(19) United States
(12) Patent Application Publication
(10) Pub. No.: US 2026/0099052 A1
(43) Pub. Date: Apr. 9, 2026

(54) VIRTUAL IMAGE DISPLAY DEVICE AND OPTICAL UNIT

(71) Applicant: SEIKO EPSON CORPORATION, Tokyo (JP)

(72) Inventor: Tokito YAMAGUCHI, AZUMINO-SHI (JP)

(73) Assignee: SEIKO EPSON CORPORATION, Tokyo (JP)

(21) Appl. No.: 19/351,240

(22) Filed: Oct. 6, 2025

(30) Foreign Application Priority Data
Oct. 7, 2024 (JP) 2024-175602

(51) Int. Cl. G02B 27/01; G02B 27/00; G02B 27/28; G02F 1/00; G02F 1/1335

(52) U.S. Cl. CPC G02B 27/0172; G02B 27/0018; G02B 27/0176; G02B 27/286; G02F 1/0045; G02F 1/133526; G02F 1/133531; G02F 1/133536; G02F 1/133555; G02B 2027/013; G02B 2027/0178

(57) ABSTRACT

A virtual image display device includes a display that emits circularly polarized video light, and an optical member that forms a virtual image. The optical member includes a lens member, a transmissive reflection optical element facing a first optical surface of the lens member, a reflective polarization optical element facing a second optical surface of the lens member, and reflecting the video light in a first polarization direction, and a waveplate element provided between the reflection optical element and the polarization optical element, formed of a photocrosslinkable polymer liquid crystal material, converting the video light into linearly polarized light in the first polarization direction, and converting the video light after reciprocation into linearly polarized light in a second polarization direction. The waveplate element has orientation of d±5° or less with respect to a gradient normal angle d of an optical surface on which the waveplate element is provided.

The present application is based on, and claims priority from JP Application Serial Number 2024-175602, filed Oct. 7, 2024, the disclosure of which is hereby incorporated by reference herein in its entirety.

### BACKGROUND

### 1. Technical Field

The present disclosure relates to a virtual image display device and an optical unit that enable observation of a virtual image.

### 2. Related Art

A pancake lens in which a front optical element and a back optical element forming optical components are integrally bonded in order to suppress ghost images when viewing a video is known (US 2018/120579). In the pancake lens of US 2018/120579, a hybrid film functioning as a polarizer and a quarter-waveplate is attached to a cylindrical surface in a vertical direction between the front optical element and the back optical element.

US 2018/120579 is an example of the related art.

In the pancake lens of US 2018/120579, the incident angle of the beam incident on the hybrid film varies depending on the cross sections in different directions, specifically, the cylindrical curved surface and the cylindrical flat surface. Therefore, there is a concern that the quality of a display video may deteriorate due to the viewing angle characteristics of the hybrid film.

### SUMMARY

A virtual image display device according to an aspect of the present disclosure includes a display configured to emit circularly polarized video light, and an optical member configured to form a virtual image by reflecting and folding the video light twice. The optical member includes a lens member including one or more lenses, a transmissive reflection optical element provided to face a first optical surface of the lens member closer to the display, a reflective polarization optical element provided to face a second optical surface of the lens member farther from the display, and reflecting the video light that is linearly polarized light in a first polarization direction, and a waveplate element provided between the reflection optical element and the polarization optical element, formed of a photocrosslinkable polymer liquid crystal material, converting the video light passing through the reflection optical element into linearly polarized light in the first polarization direction, and converting the video light reflected by the reflection optical element and reciprocated to the waveplate element into linearly polarized light in a second polarization direction. The waveplate element has orientation of d±5° or less with respect to a gradient normal angle d of an optical surface on which the waveplate element is provided.

An optical unit according to an aspect of the present disclosure includes a display configured to emit circularly polarized video light, and an optical member configured to form a virtual image by reflecting and folding the video light twice. The optical member includes a lens member including one or more lenses, a transmissive reflection optical element provided to face a first optical surface of the lens member closer to the display, a reflective polarization optical element provided to face a second optical surface of the lens member farther from the display, and reflecting the video light that is linearly polarized light in a first polarization direction, and a waveplate element provided between the reflection optical element and the polarization optical element, formed of a photocrosslinkable polymer liquid crystal material, converting the video light passing through the reflection optical element into linearly polarized light in the first polarization direction, and converting the video light reflected by the reflection optical element and reciprocated to the waveplate element into linearly polarized light in a second polarization direction. The waveplate element has orientation of d±5° or less with respect to a gradient normal angle d of an optical surface on which the waveplate element is provided.

### BRIEF DESCRIPTION OF THE DRAWINGS

FIG. 1 is an external perspective view illustrating a mounted state of a virtual image display device according to a first embodiment.

FIG. 2 is a side sectional view illustrating an optical structure of a display optical system.

FIG. 3 illustrates an exposure device.

FIG. 4 illustrates spherical wave exposure.

FIG. 5 is a conceptual diagram illustrating an optical operation of the virtual image display device.

FIG. 6 illustrates setting conditions of the virtual image display device.

FIG. 7 illustrates plane wave exposure.

FIG. 8 is a graph illustrating beam incident angles of the plane wave exposure in a waveplate element.

FIG. 9 is a graph illustrating general viewing angle characteristics of a waveplate element.

FIG. 10 is a graph illustrating a beam incident angle in a waveplate element of spherical wave exposure.

FIG. 11 is a graph illustrating the relationship between F-number and a ratio of radii of curvature.

FIG. 12 shows graphs illustrating beam incident angles of waveplate elements of an example and a comparative example.

FIG. 13 shows graphs illustrating luminance unevenness, color unevenness, and ghost of the waveplate elements of an example and a comparative example.

FIG. 14 illustrates verification of viewing angle characteristics of the waveplate element.

FIG. 15 is a side sectional view illustrating an optical structure of a display optical system according to a second embodiment.

FIG. 16 is a side sectional view illustrating an optical structure of a display optical system according to a modification.

FIG. 17 illustrates fabrication of a waveplate element according to a modification.

### DESCRIPTION OF EMBODIMENTS

### First Embodiment

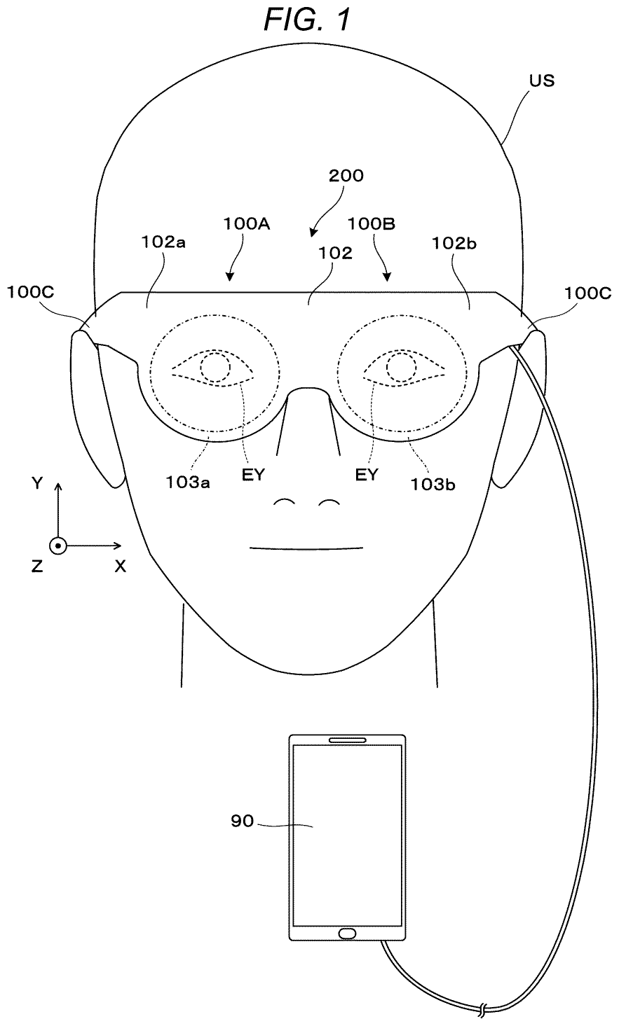

Hereinafter, a virtual image display device and the like according to a first embodiment of the present disclosure will be described with reference to FIG. 1 and the like.

FIG. 1 is a perspective view illustrating a mounted state of a head-mounted display, that is, a head-mounted display apparatus 200. The head-mounted display apparatus (hereinafter also referred to as HMD) 200 causes an observer or a wearer US wearing the apparatus to recognize a video as a virtual image. In FIG. 1 and the like, X, Y, and Z represent an orthogonal coordinate system. A +X direction corresponds to a lateral direction in which both eyes EY of the observer or wearer US wearing the HMD 200 are arranged. A +Y direction corresponds to an upward direction orthogonal to the lateral direction in which both eyes EY of the wearer US are arranged. A +Z direction corresponds to a forward direction or a frontward direction of the wearer US. The Y directions are parallel to the vertical axis or the vertical direction.

The HMD 200 includes a first virtual image display device 100A for the right eye, a second virtual image display device 100B for the left eye, a pair of temples 100C that support the virtual image display devices 100A and 100B, and a user terminal 90 that is an information terminal. The first virtual image display device 100A includes a first display drive unit 102a disposed in an upper portion and a first display optical system 103a that covers the front of the eye. The second virtual image display device 100B includes a second display drive unit 102b disposed in an upper portion and a second display optical system 103b that covers the front of the eye. The HMD 200 with a combination of the first virtual image display device 100A and the second virtual image display device 100B is also a virtual image display device in a broad sense. The pair of temples 100C support the upper end sides of the pair of display optical systems 103a and 103b via the display drive units 102a and 102b integrated in appearance. A combination of the pair of display drive units 102a and 102b is referred to as a drive device 102.

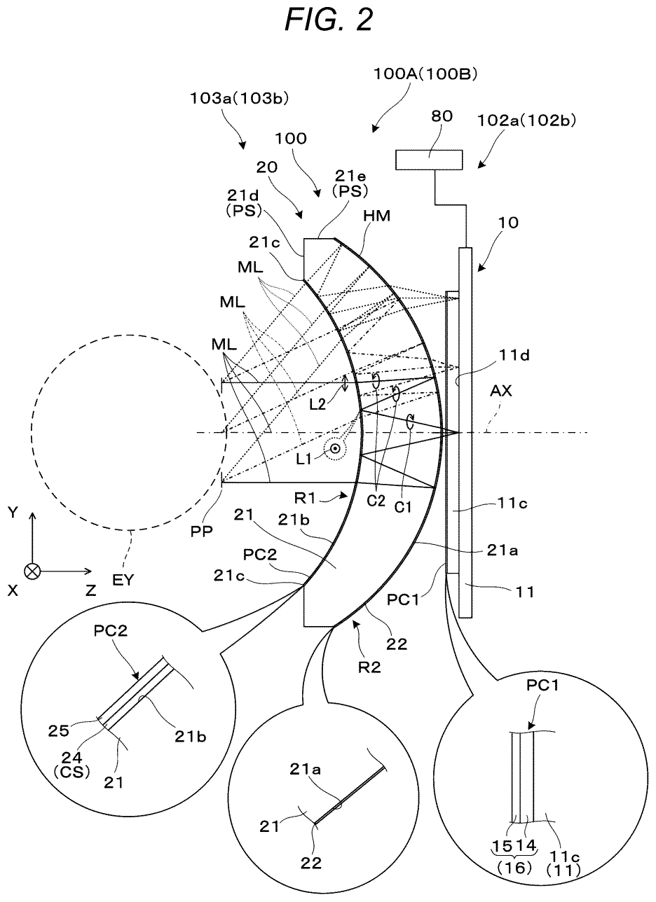

FIG. 2 is a conceptual side view illustrating a structure of the first display optical system 103a. The first display optical system 103a includes a display 10 that emits circularly polarized video light ML, an optical member 20 that forms a virtual image by reflecting and folding the video light ML twice, and a circuit member 80 that controls the operation of the display 10 and the like.

In the first virtual image display device 100A, the optical device except the circuit member 80 (specifically, the display 10 and the optical member 20) is referred to as an optical unit 100.

Although the detailed description is omitted, the second virtual image display device 100B or the second display optical system 103b is optically identical with the first virtual image display device 100A or the first display optical system 103a, or is obtained by horizontally inverting the first virtual image display device 100A or the first display optical system 103a. Hereinafter, the first virtual image display device 100A or the first display optical system 103a will be described, and the description of the second virtual image display device 100B or the second display optical system 103b will be omitted.

In the case of the illustrated first display optical system 103a, around FOV 100°, specifically, FOV 120° is achieved, and the thickness from the display 10 to a rear end emission surface 21c at the outer edge of the optical member 20 is about 10 mm to 15 mm.

In the first display optical system 103a, the display 10 includes an image display panel 11 that is a self-emitting video light generation device, and a first polarization control member PC1 that converts the video light ML emitted from the image display panel 11 into circularly polarized light.

The image display panel 11 is, for example, an OLED (organic light emitting diode) display, and forms a monochrome or color still image or moving image on a two-dimensional display surface 11d. The video light ML emitted from the image display panel 11 includes randomly polarized light. The image display panel 11 is driven by the circuit member 80 to perform a display operation. The image display panel 11 is not limited to the OLED display, but can be replaced with a display device using a micro OLED, an organic EL (organic electroluminescence, Organic Electro-Luminescence), an inorganic EL, an LED, a micro LED, an LED array, a laser array, a quantum dot light-emitting element, or the like.

The image display panel 11 is not limited to a self-emitting video light generation device, but may include an LCD or another light modulation element and may form an image by illuminating the light modulation element with a light source such as a background. As the image display panel 11, an LCOS (Liquid crystal on silicon, LCoS is a registered trademark), a digital micromirror device (specifically, DLP: registered trademark), laser beam scanning, or the like may be used instead of the LCD.

The first polarization control member PC1 includes a linear polarizer 14 and a quarter-waveplate 15 in this order from the image display panel 11 side. When the image display panel 11 is an OLED, the first polarization control member PC1 may be a circular polarizer 16 in which the linear polarizer 14 and the quarter-waveplate 15 are bonded to each other.

The linear polarizer 14 is, for example, an absorption-type polarizer, and in the present embodiment, selectively passes only second linearly polarized light (vertically polarized light) in the Y direction as the vertical direction. That is, only the linearly polarized light in the Y direction of the video light ML emitted from the image display panel 11 passes through the linear polarizer 14 and is incident on the quarter-waveplate 15. The linear polarizer 14 has a sheet shape, and is fabricated by stretching a film in which polyvinyl alcohol (PVA) is impregnated with a dichroic dye such as iodine in a certain direction.

The main axis or fast axis of the quarter-waveplate 15 is set between the vertical direction and the horizontal direction, that is, between the Y direction and the X direction, and the quarter-waveplate converts the second linearly polarized light (vertically polarized light) having passed through the linear polarizer 14 into, for example, right circularly polarized light C1. The quarter-waveplate 15 is formed of, for example, a liquid crystal material such as a photocrosslinkable polymer liquid crystal material, but may be formed by processing a birefringent crystal material such as quartz crystal into a thin plate. As a specific fabrication method, the linear polarizer 14 is provided on a cover glass 11c of the image display panel 11, and the quarter-waveplate 15 formed of an ultraviolet curable photocrosslinkable polymer liquid crystal material is provided thereon. The photocrosslinkable polymer liquid crystal material is applied onto the cover glass 11c while controlling the film thickness by spin coating, inkjet, or the like, then irradiated with polarized ultraviolet rays or ultraviolet light, and then baked to function as the quarter-waveplate 15.

The optical member 20 includes a reflection optical element 22, a lens member 21, and a second polarization control member PC2 in this order from the image display panel 11 side. In the optical member 20, the second polarization control member PC2 includes a waveplate element 24 and a reflective polarization optical element 25 in this order from the image display panel 11 side. That is, the waveplate element 24 is provided between a second optical surface 21b of the lens member 21 and the polarization optical element 25.

In the present embodiment, the number of lenses of the lens member 21 forming the optical member 20 for imaging is one, which is an optically very simple configuration. Since the lens member can be formed using one lens, the number of components is simply smaller, and the process of bonding lenses is unnecessary, so that the cost can be reduced. Therefore, the weight of the entire optical system can be made very light.

The lens member 21 is a concavo-convex lens or a meniscus lens having positive power, and has a first optical surface 21a at the incident side and a second optical surface 21b at the emission side. The first optical surface 21a and the second optical surface 21b are curved surfaces, specifically, spherical surfaces or aspherical surfaces.

The first optical surface 21a is a convex surface, and the second optical surface 21b is a concave surface. When the first optical surface 21a is a convex surface, the reflection optical element 22 can be provided with positive power, and the first virtual image display device 100A can be easily downsized by reducing the distance between the display 10 and the optical member 20. When the second optical surface 21b is a concave surface, the beam angle of the video light ML emitted from the image display panel 11 can be inclined toward inside, that is, an optical axis AX, the refraction of the principal ray in the second optical surface 21b of the lens member 21 can be reduced as a whole, and the aberration of the optical member 20 can be easily reduced.

The lens member 21 has an annular first end surface 21d that is an outer edge of the optical member 20 and extends from an edge portion of the second optical surface 21b in a radial direction perpendicular to the optical axis AX and in parallel or substantially parallel to the Y direction. Further, the lens member 21 has a cylindrical second end surface 21e that is an outer edge of the optical member 20 and extends from an edge portion of the first optical surface 21a in parallel or substantially parallel to the Z direction. The first end surface 21d and the second end surface 21e are orthogonal to each other. The first and second end surfaces 21d and 21e function as, for example, positioning portions PS or positioning surfaces for positioning with respect to a case (not illustrated). The second polarization control member PC2, that is, the waveplate element 24 and the polarization optical element 25 are not provided on the first end surface 21d, and the surface is exposed. The reflection optical element 22 is not provided on the second end surface 21e, and the surface is exposed. As a result, for example, unnecessary reflection of the video light ML can be prevented.

The lens member 21 is formed using, for example, resin, but may be formed using glass. The lens member 21 formed using glass is advantageous from the viewpoint of downsizing.

The reflection optical element 22 is provided to face the first optical surface 21a. That is, the first optical surface 21a and the reflection optical element 22 have the same shape, but the first optical surface 21a functions as a convex refractive surface, and the reflection optical element 22 functions as a concave reflection surface. In contrast, the polarization optical element 25 is provided to face the second optical surface 21b, and more specifically, is formed at the second optical surface 21b via the thin film-shaped waveplate element 24. That is, the second optical surface 21b and the polarization optical element 25 have the same shape, but the second optical surface 21b functions as a concave refractive surface, and the polarization optical element 25 functions as a convex reflection surface.

The reflection optical element 22 is transmissive half mirror HM and partially transmits and partially reflects the video light ML. The reflection optical element 22 covers a pupil position PP at which the eye EY or the pupil is disposed, has a concave shape toward the pupil position PP, and has a convex shape toward the outside. The reflectance of the reflection optical element 22 with respect to the video light ML is, for example, about 50% from the viewpoint of securing the luminance of the video light ML, but is not limited thereto. The reflection optical element 22 is a single-layer film or a multilayer film of a metal such as Al or Ag having an adjusted film thickness. The reflection optical element 22 can be formed by lamination using vapor deposition, for example, but can also be formed by attaching a sheet-shaped reflective film.

The main axis or fast axis of the waveplate element 24 is set between the vertical direction and the horizontal direction, that is, between the Y direction and the X direction, and corresponds to a quarter-waveplate. The waveplate element 24 has a quarter-wave phase state on the entire surface. That is, the waveplate element 24 converts circularly polarized light passing through the lens member 21, for example, right circularly polarized light C1 into first linearly polarized light (horizontally polarized light) L1 in a first polarization direction corresponding to the X direction as the horizontal direction. The waveplate element 24 converts the first linearly polarized light L1 reflected by the polarization optical element 25 into left circularly polarized light C2. The waveplate element 24 converts the left circularly polarized light C2 passing through the waveplate element 24 twice and reflected again by the reflection optical element 22 via the lens member 21 into second linearly polarized light (vertically polarized light) L2 in a second polarization direction corresponding to the perpendicular direction or the Y direction as the vertical direction. The waveplate element 24 is formed of a liquid crystal material such as a photocrosslinkable polymer liquid crystal material. The waveplate element 24 is a thin-film waveplate formed on the second optical surface 21b, and is specifically formed of an ultraviolet curable photocrosslinkable polymer liquid crystal material.

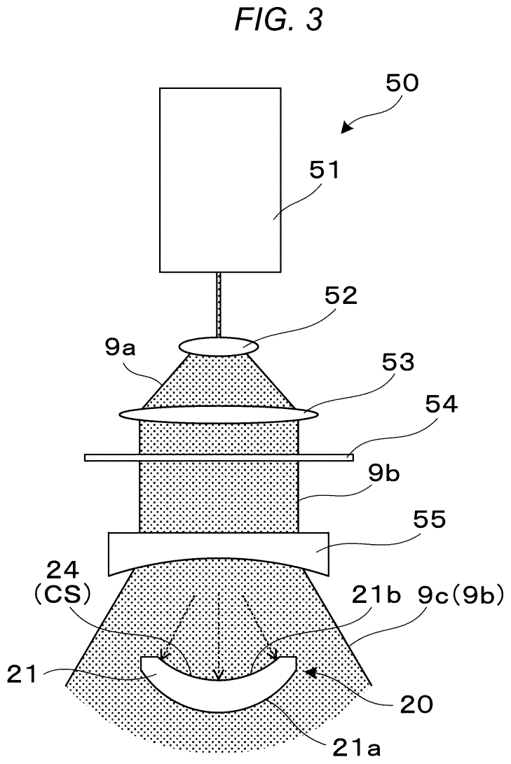

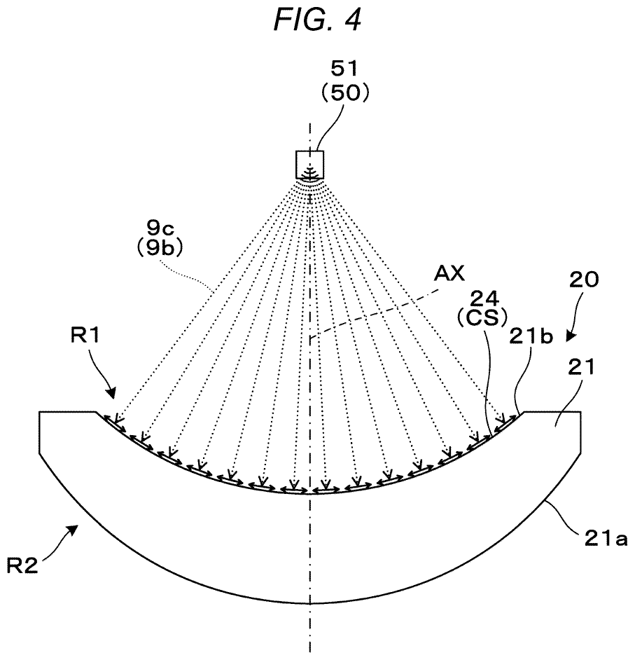

Fabrication of the waveplate element 24 will be described. FIG. 3 illustrates an exposure device 50. FIG. 4 illustrates spherical wave exposure. As shown in FIG. 3, a photocrosslinkable polymer liquid crystal material CS forming the waveplate element 24 is exposed using the exposure device 50. The orientation of the waveplate element 24 is formed by exposure light 9c of the exposure device 50. The photocrosslinkable polymer liquid crystal material CS is applied onto the second optical surface 21b of the lens member 21 to form a photocrosslinkable polymer liquid crystal material layer, that is, a thin film. The thin film of the photocrosslinkable polymer liquid crystal material CS is irradiated with polarized UV 9b as linearly polarized ultraviolet rays in the controlled polarization direction. In the present embodiment, spherical wave exposure is performed on the lens member 21 to which the photocrosslinkable polymer liquid crystal material CS is applied. Accordingly, the orientation state of rod-shaped molecular species (that is, molecules having a refractive index difference between the major axis and the minor axis) that exhibit liquid crystallinity while curing the thin film of the photocrosslinkable polymer liquid crystal material CS can be controlled. Here, among the molecular species that exhibit liquid crystallinity by an ultraviolet ray, the molecular species extending in a direction matching the polarization direction of the ultraviolet rays are crosslinked, and the orientation state is fixed in the same direction as the polarization direction.

As illustrated in FIG. 3, the exposure device 50 includes a UV laser beam source 51, a diffusion lens 52, a collimator lens 53, a linear polarizer 54, and a spherical wave forming lens 55. The spherical wave forming lens 55 adjusts the exposure light 9c into desired spherical wave, and is provided at the emission side of the linear polarizer 54. The lens member 21 is placed in a state in which the second optical surface 21b with the photocrosslinkable polymer liquid crystal material CS applied thereto faces the exposure side. The diffusion lens 52 diffuses ultraviolet rays 9a emitted from the UV laser beam source 51. The collimator lens 53 collimates the ultraviolet rays 9a diffused by the diffusion lens 52. The linear polarizer 54 converts the ultraviolet rays 9a collimated by the collimator lens 53 into the polarized UV 9b as desired linearly polarized light. The spherical wave forming lens 55 adjusts the polarized UV 9b emitted from the linear polarizer 54 into a spherical wave shape as the exposure light 9c. The exposure light 9c emitted from the spherical wave forming lens 55 is applied to the photocrosslinkable polymer liquid crystal material CS applied onto the second optical surface 21b.

In the above-described spherical wave exposure, substantially spherical wave of d±5° or less with respect to a gradient normal angle d of the second optical surface 21b of the lens member 21 provided with the waveplate element 24 is used for exposure. Accordingly, the waveplate element 24 has orientation of d±5° or less with respect to the gradient normal angle d of the second optical surface 21b. Further, a beam incident angle on the waveplate element 24 is 10° or less at the maximum, and an angle difference when the beam is incident on the waveplate element 24 three times, which will be described later, can also be ±5% or less. Here, the beam incident angle on the waveplate element 24 is considered as an incident angle with respect to the optical axis AX direction. The gradient normal angle d is an angle formed by an axis parallel to the optical axis AX and the normal of the second optical surface 21b. When an intersection with the second optical surface 21b with reference to the optical axis AX, the angle difference ±5° of the substantially spherical wave can be obtained from (i) the difference between the optical axis AX and the normal direction of the second optical surface 21b at the intersection position (gradient normal angle d) and (ii) the difference between the optical axis AX and the direction vector of the spherical wave at the intersection with the second optical surface 21b. When only the angle difference is considered, the angle difference may be obtained by a spherical wave vector and a normal vector of the second optical surface 21b at the intersection position of the beam with the second optical surface 21b. The gradient normal angle d with respect to the peripheral surface of the lens member 21 is larger than the gradient normal angle d with respect to the central surface of the lens member 21. As shown in FIG. 4, when exposure is performed with spherical wave having the same radius of curvature as a first radius of curvature R1 of the second optical surface 21b so that the beam incident angle on the waveplate element 24 follows the gradient of the curved surface having the first radius of curvature R1, the liquid crystal molecules are arranged to follow the gradient direction of the second optical surface 21b.

After irradiation with the exposure light 9c, the thin film of the photocrosslinkable polymer liquid crystal material CS is annealed. As a result, the molecular species exhibiting liquid crystallinity, the orientation state of which is not changed by ultraviolet rays, can be converted into liquid crystal, the orientation state can be matched with the polymer portion already in the target alignment state, and the alignment state is fixed by subsequent cooling. That is, a waveplate formed of a thin film in which most of the orientation directions of the molecular species expressing liquid crystallinity forming the photocrosslinkable polymer liquid crystal material CS are matched, that is, the waveplate element 24 can be obtained.

The polarization optical element 25 is a wire grid polarizer, selectively reflects the first linearly polarized light L1 in the first polarization direction corresponding to the X direction as the horizontal direction, and selectively transmits only the second vertically polarized light L2 in the second polarization direction corresponding to the perpendicular direction or the Y direction as the vertical direction. The wire grid polarizer is used as the polarization optical element 25, and thus the polarization optical element 25 can be bonded onto the second optical surface 21b via the waveplate element 24, and even when the second optical surface 21b is a curved surface, it is easier to form the polarization optical element 25 on the second optical surface 21b. The polarization optical element 25 is, for example, a reflective polarizer having a structure in which a large number of metal thin wires made of aluminum, nickel, or the like are arranged in parallel on a transparent resin substrate having flexibility, and a wire grid layer of the large number of metal thin wires is covered with a transparent protective layer. The polarization optical element 25 reflects linearly polarized light having an electric field component parallel to the direction in which the large number of thin metal wires extend and perpendicular to the periodic direction corresponding to the alignment direction (corresponding to the polarization direction). The main body of the polarization optical element 25 is fabricated by transferring a concavo-convex shape to the surface of a resin film formed of a UV resin or a thermoplastic resin using a mold having a concavo-convex structure, and then depositing aluminum in an oblique direction on the top portions and side surfaces of the convex portions of the concavo-convex shape using a vacuum deposition method. The main body of the polarization optical element 25 can also be fabricated by applying a polymer solution onto a mold having a concavo-convex structure using a spin coating method and curing the polymer solution formed on the surface of the mold (see, for example, JP-A-2011-221334). The polarization optical element 25 thus obtained is fixed to the lens member 21 by being attached to the waveplate element 24 using, for example, an adhesive.

The polarization optical element 25 may not be a wire grid polarizer, but may be, for example, a polarizer or a multilayer film of a type in which a plurality of films having anisotropy by rolling are laminated, or a dielectric multilayer film formed by vacuum deposition.

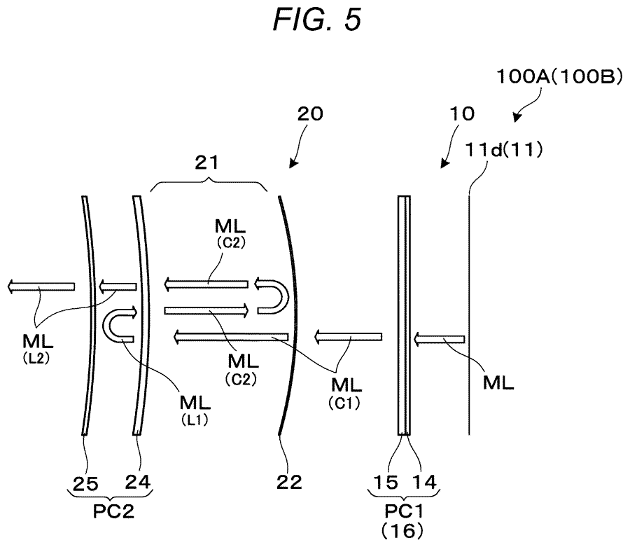

FIG. 5 is a conceptual diagram illustrating an optical operation of the first virtual image display device 100A. As shown in FIG. 5, the video light ML emitted from the display 10 passes through the first polarization control member PC1 and is converted into the right circularly polarized light C1. The video light ML as the right circularly polarized light C1 incident on the optical member 20 from the display 10 is partially transmitted through the reflection optical element 22, but is attenuated to about half the intensity when transmitted. The video light ML transmitted through the reflection optical element 22 passes through the lens member 21 and passes through the waveplate element 24. Concurrently, the video light ML is refracted by the lens member 21 and is relatively converged by the positive power. The video light ML passes through the waveplate element 24 from the forward direction to be converted from the right circularly polarized light C1 into the first linearly polarized light L1 in the first polarization direction, and is incident on the polarization optical element 25. The video light ML incident on the polarization optical element 25 is efficiently reflected as the first linearly polarized light L1 by the polarization optical element 25, and passes through the waveplate element 24 from the backward direction when passing through the lens member 21. The video light ML passing through the waveplate element 24 from the backward direction is converted into left circularly polarized light C2. The video light ML emitted from the lens member 21 through the waveplate element 24 is reflected by the reflection optical element 22 and relatively converged by the positive power, but is attenuated to about half the intensity at the reflection. The video light ML of the left circularly polarized light C2 reflected by the reflection optical element 22 passes through the waveplate element 24 from the forward direction via the lens member 21, is converted into the second linearly polarized light L2 in the second polarization direction, and is incident on the polarization optical element 25. As described above, the video light ML reciprocates through the lens member 21 at reflection by the reflection optical element 22, passes through the lens member 21 twice by the reciprocation, and consequently passes through the lens member 21 three times. The video light ML incident on the polarization optical element 25 via the lens member 21 efficiently passes through the polarization optical element 25 as the second linearly polarized light L2 in the second polarization direction. The video light ML emitted to the outside of the optical member 20 is incident on the pupil position PP at which the eye EY of the wearer US is disposed in a collimated state by the converging action of the optical member 20 (see FIG. 2). That is, the wearer US wearing the first virtual image display device 100A can observe a virtual image by the video light ML.

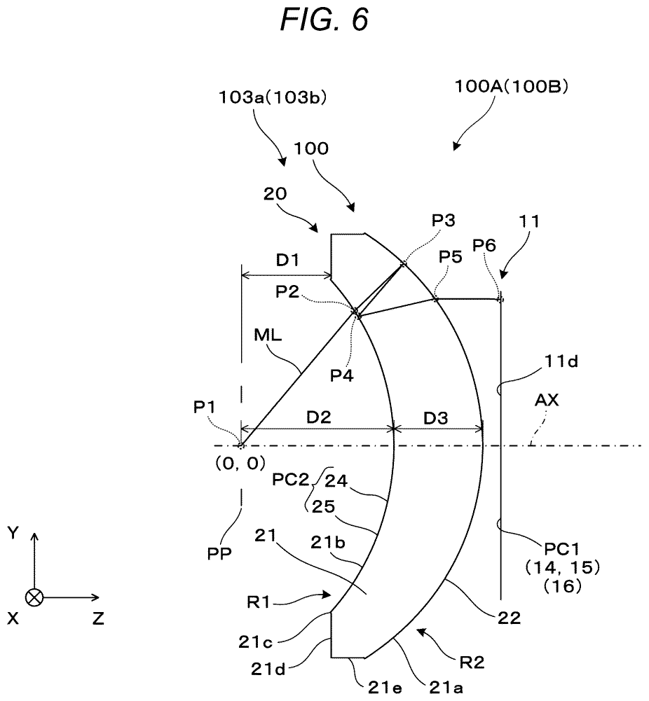

FIG. 6 illustrates setting conditions of the first virtual image display device 100A. As shown in FIG. 6, as the HMD 200 shown in FIG. 1, an eye relief length D1 fitting the shape of the face of the wearer US is set to 8 mm or more, and the F-number of the optical member 20 is set to 1.0 to 2.0. The eye relief length D1 is an axial distance from an end portion of axially closest to the pupil position PP in the second optical surface 21b of the lens member 21, that is, the first end surface 21d to the pupil position PP. In this case, the first radius of curvature R1 of the reflection surface of the polarization optical element 25 facing the second optical surface 21b of the lens member 21 and the second radius of curvature R2 of the reflection surface of the reflection optical element 22 facing the first optical surface 21a of the lens member 21 are set to satisfy the following expression.

$$0. 8 \leq R 2 / R 1 \leq 1.2$$

Here, it is considered that the second optical surface 21b of the lens member 21 and the reflection surface of the polarization optical element 25 have the same or substantially the same shape having the first radius of curvature R1. Further, it is considered that the first optical surface 21a of the lens member 21 and the reflection surface of the reflection optical element 22 have the same or substantially the same shape having the second radius of curvature R2. When the first and second optical surfaces 21a and 21b of the lens member 21 are aspherical surfaces, the first and second radii of curvature R1 and R2 are considered as approximate radii of curvature.

The ratio of the radii of curvature (R2/R1) preferably satisfies the following condition.

$$1. 0 \leq R 2 / R 1 \leq 1.2$$

As described above, in the first display optical system 103a, the video light ML emitted from the display 10 is incident three times on the waveplate element 24 provided on the second optical surface 21b of the lens member 21. The video light ML is incident three times on the waveplate element 24, and thus the beam can be folded back while the video light ML is being converted into linearly polarized light in a predetermined direction, for example, horizontally polarized light into vertically polarized light. Here, when the passage and the reflection angle of the beam at each angle of view are considered and the beam is followed from the pupil position PP side, the coordinate positions (z, r) of points P1 to P6 illustrated in FIG. 6 and the angle of the incident beam on the waveplate element 24 can be calculated as follows.

The expression of the beam at the angle of view emitted from the point P1 is expressed as follows.

$$z = r * tan θ$$

Regarding the coordinates of the point P2, the curved surface expression (1) of the second optical surface 21b is expressed as follows.

$$z = \frac{c {r}^{2}}{1 + \sqrt{1 - {c}^{2} {r}^{2}}} + {\sum }_{i = 4}^{n} {A}_{i} {r}^{i}$$

For simplification, the lens curved surface of the second optical surface 21b is a spherical surface, and the beam angle with respect to the lens curved surface normal direction is considered. The gradient of the lens curved surface at the point (z, r) is expressed as follows by differentiating the curved surface expression (1) in the radius r direction.

$${z}^{′} = \frac{\partial z}{\partial r} = \frac{2 cr ( 1 + \sqrt{1 - {c}^{2} {r}^{2}} ) + \frac{{c}^{3} {r}^{3}}{\sqrt{1 - {c}^{2} {r}^{2}}}}{{( 1 + \sqrt{1 - {c}^{2} {r}^{2}} )}^{2}}$$

The normal of the curved surface at the point (z, r) is given by −1/z′. When the refraction and the reflection in the lens member 21 are calculated according to the expression, although not illustrated, the beam at each angle of view can be plotted as a graph.

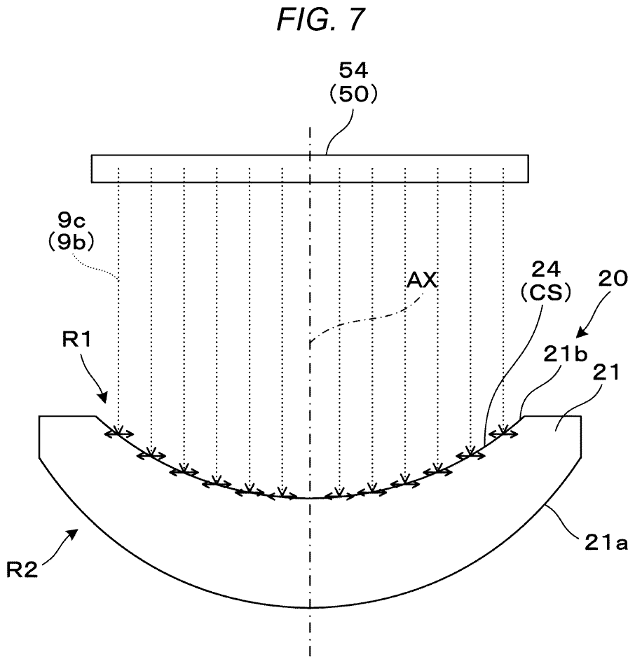

In consideration of the influence (viewing angle characteristics) of the beam incident angle on the waveplate element 24, the polarization UV exposure direction (optical axis of the retardation film) for fabrication of the phase difference function of the waveplate element 24 is important. As illustrated in FIG. 7, as a comparative example, when plane wave exposure is performed in the optical axis AX direction of the lens member 21, liquid crystal molecules are arranged in a direction along the plane wave. Note that the plane wave exposure is performed without the spherical wave forming lens 55 in the exposure device 50 shown in FIG. 3.

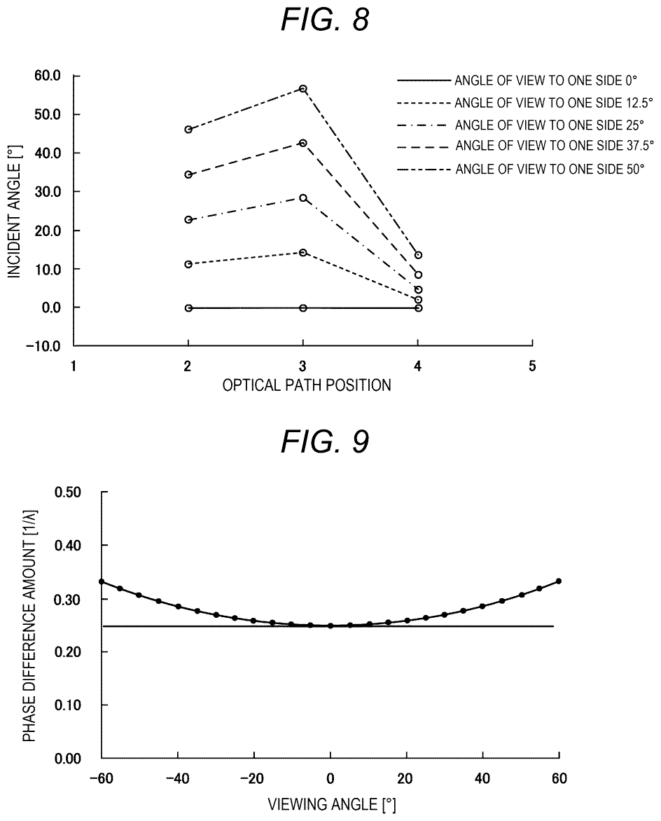

FIG. 8 is a graph illustrating beam incident angles (angles with respect to the optical axis AX direction) when the beam of the plane wave exposure passes through the waveplate element 24 in the optical paths from the point P2 to the point P4 illustrated in FIG. 6 as a comparative example. FIG. 8 shows a result of calculation of the beam incident angles (beam passing angles) on the waveplate element 24 with respect to the normal of the second optical surface 21b (the curved surface having the first radius of curvature R1) for all angles of view of the first display optical system 103a.

As shown in FIG. 8, regarding the beam at the end of the angle of view, the incident angle exceeds 50°. For good video characteristics, it is necessary that the viewing angle characteristics of the waveplate element 24 support an angle exceeding 50°. However, in consideration of the general viewing angle characteristics of the waveplate element 24 shown in FIG. 9, it is considerably hard to support 50°, and the phase difference greatly deviates from the phase difference of the 0.25 wavelength as a target of the waveplate element 24.

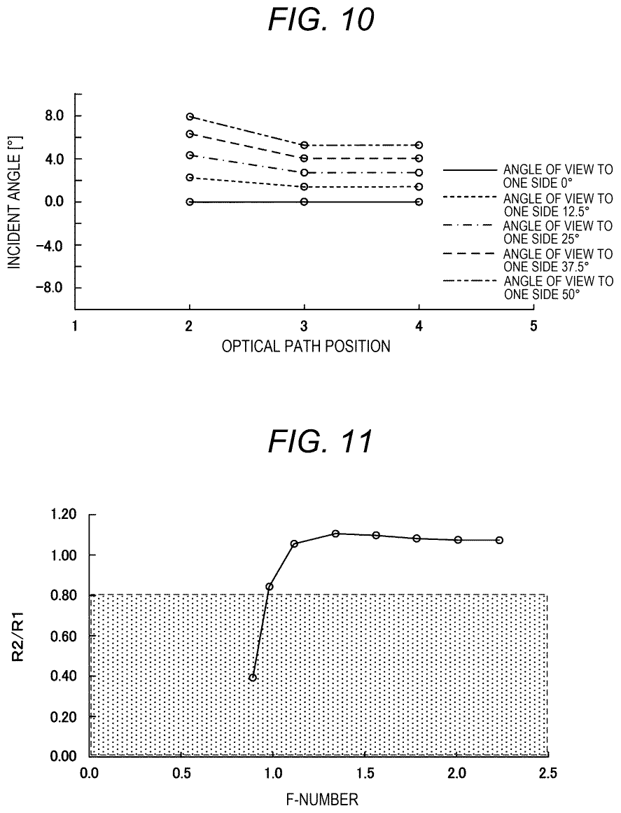

Therefore, when exposure is performed with spherical wave having the same radius of curvature as the first radius of curvature R1 so that the beam incident angle on the waveplate element 24 follows the gradient of the curved surface having the first radius of curvature R1 corresponding to the second optical surface 21b, as shown in FIG. 4, the liquid crystal molecules are arranged to follow the gradient direction of the second optical surface 21b. Accordingly, the beam incident angle when the beam passes through the waveplate element 24 may be regarded as an angle with respect to the normal direction of the curved surface having the first radius of curvature R1 corresponding to the second optical surface 21b. FIG. 10 is a graph illustrating the beam incident angles on the waveplate element 24 in the spherical wave exposure of the present embodiment with respect to the normal of the second optical surface 21b (the curved surface having the first radius of curvature R1) for all angles of view. As shown in FIG. 10, as compared with the comparative example shown in FIG. 8, the beam incident angles are one-fifth or less, and the viewing angle characteristics at the level are considered to be realistic. Further, the amounts of deviation from the target phase difference of the waveplate element 24 are small.

On the other hand, as shown in FIG. 2, the beam incident angle on the waveplate element 24 is determined by the condensing state of the beam in the first display optical system 103a, that is, the power distribution of the optical surface from the pupil position PP to the image display panel 11. In particular, the ratio of the radii of curvature of the two reflection surfaces, specifically, the ratio between the first radius of curvature R1 of the polarization optical element 25 and the second radius of curvature R2 of the reflection optical element 22 is important. Since the first radius of curvature R1 and the second radius of curvature R2 are determined by the F-number of the lens member 21, the F-number and the ratio of the radii of curvature (R2/R1), and the F-number and the beam incident angle on the waveplate element 24 (global and surface normal basis) were examined.

FIG. 11 is a graph illustrating the relationship between the F-number and the ratio of the radii of curvature (R2/R1). As shown in FIG. 11, when the F-number is smaller than 1.0, desired optical characteristics cannot be obtained, and the design becomes generally difficult. In a region where the F-number is 1.0 or more, the ratio of the radii of curvature (R2/R1) satisfies the following condition.

$$0. 8 \leq R 2 / R 1 \leq 1.2$$

When the F-number is 1.0 or more, it is preferable that the ratio of the radii of curvature (R2/R1) satisfies the following condition.

$$1. 0 \leq R 2 / R 1 \leq 1.2$$

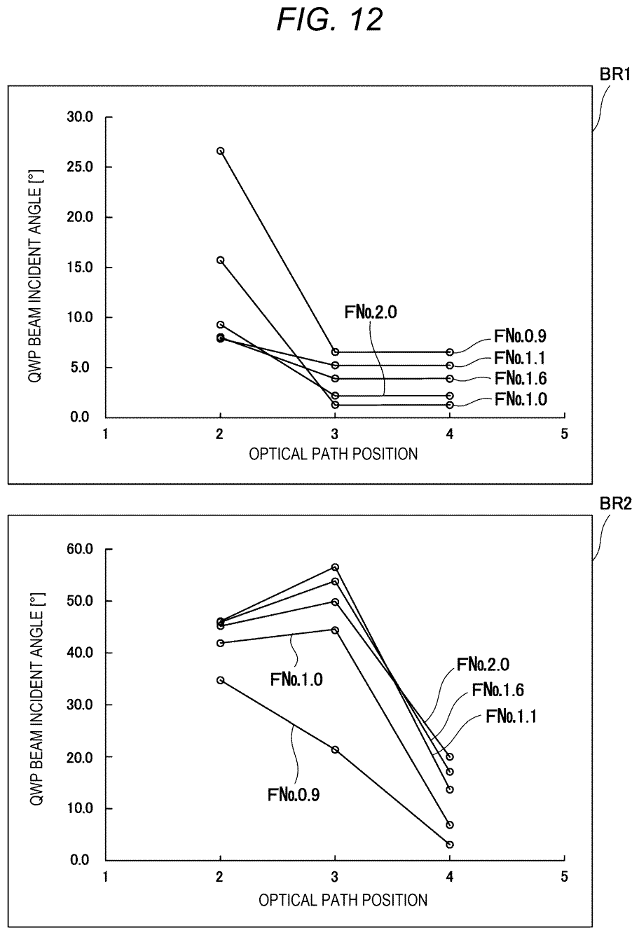

Further, the number of times of incidence on the waveplate element 24 and the incident angle of the beam at the end of the angle of view are compared between the plane wave exposure and the spherical wave exposure. A region BR1 in FIG. 12 shows a graph illustrating beam incident angles of the spherical wave exposure on the waveplate element 24 in the beam at the end of the angle of view as an example. A region BR2 in FIG. 12 shows a graph illustrating beam incident angles of the plane wave exposure on the waveplate element 24 in the beam at the end of the angle of view as a comparative example. In FIG. 12, QWP indicates the waveplate element 24. As shown in the region BR1 of FIG. 12, when the spherical wave exposure is performed with reference to the surface normal, the incident angle is generally 10° or less except for the cases where the F-number is 0.9 and 1.0. On the other hand, as shown in the region BR2 of FIG. 12, when the plane wave exposure is performed with reference to the optical axis AX, the incident angle on the waveplate element 24 is generally 50° or more.

Next, video characteristics (specifically, luminance unevenness, color unevenness, and ghost) in the display screen are compared between the plane wave exposure and the spherical wave exposure in a simulation. In the simulation, output information on the pupil position PP (see FIG. 2) with respect to input information was calculated. Specifically, between the input information and the output information on the video, arithmetic processing was sequentially performed on the circular polarizer 16 (the linear polarizer 14 and the quarter-waveplate 15), the reflection optical element 22, the waveplate element 24, the polarization optical element 25, the waveplate element 24, the reflection optical element 22, the waveplate element 24, and the polarization optical element 25, specifically, polarization calculation of Stokes vectors using the Mueller matrix was performed on the spectral intensity and the polarization state. As the input information, information on the angle of view and the spectral intensity of the video light ML is input. In the arithmetic processing on the respective elements 16, 22, 24, and 25, information on the incident angle, the polarization state, and the like is appropriately input.

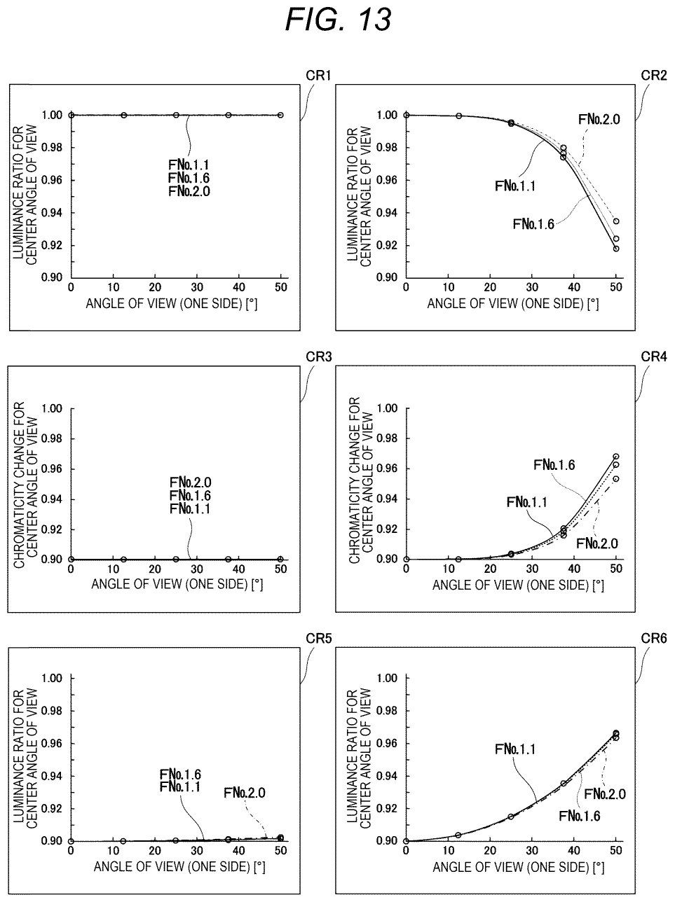

FIG. 13 shows graphs illustrating results of comparison in luminance unevenness, color unevenness, and ghost (video light ratio) between the plane wave exposure and the spherical wave exposure at an angle of view position (one side) for each F-number. A region CR1 in FIG. 13 shows a graph illustrating luminance ratios at angle of view positions in an example. A region CR2 in FIG. 13 shows a graph illustrating luminance ratios at angle of view positions in a comparative example. A region CR3 in FIG. 13 shows a graph illustrating chromaticity changes at angle of view positions in the example. A region CR4 in FIG. 13 shows a graph illustrating chromaticity changes at angle of view positions in the comparative example. A region CR5 in FIG. 13 shows a graph illustrating ghost ratios at angle of view positions in the example. A region CR6 in FIG. 13 shows a graph illustrating ghost ratios at angle of view positions in the comparative example. The ghost ratio is a ratio of luminance of a ghost to luminance of a video region or a video light.

As shown in the regions CR1 and CR2 of FIG. 13, in the case of spherical wave exposure, luminance unevenness is improved by 10% in the screen as compared with the case of plane wave exposure. As shown in the regions CR3 and CR4 of FIG. 13, the influence of the viewing angle characteristics of the waveplate element 24 on the color unevenness is originally small, but an improvement effect is observed. When the chromaticity change exceeds 0.01, the chromaticity change becomes visible as color unevenness. As shown in the regions CR5 and CR6 of FIG. 13, in the case of the plane wave exposure, 60% of the video light ML is a ghost, whereas in the case of the spherical wave exposure, the ghost can be reduced to about 1% to 28, and a large effect is expected.

### Example 1

Example 1 of the present embodiment will be described below. Parameters of the first display optical system 103a of Example 1 are shown below. Each sign corresponds to the sign illustrated in FIGS. 2 and 6.

FOV: 100°

A lens thickness D3: 7.3 mm

A distance D2 from the pupil position PP to the center of the second optical surface 21b: 14.2 mm The first radius of curvature R1 of the second optical surface 21b: −21.40 mm

The second radius of curvature R2 of the first optical surface 21a: −23.60 mm

The ratio of the radii of curvature (R2/R1)=1.103

### Example 2

Example 2 of the present embodiment will be described below. Parameters of the first display optical system 103a of Example 2 are shown below.

FOV: 100°

The lens thickness D3: 7.3 mm

The distance D2 from the pupil position PP to the center of the second optical surface 21b: 13.3 mm

The first radius of curvature R1 of the second optical surface 21b: 21.70 mm

The second radius of curvature R2 of the first optical surface 21a: 21.64 mm

The ratio of the radii of curvature (R2/R1)=0.997

In Examples 1 and 2, the configuration direction of the waveplate element 24, that is, the exposure direction of the polarized UV is configured with spherical wave exposure along the normal direction of the curved surface of the second optical surface 21b. Here, the incident angle when the beam passes through the waveplate element 24 is as shown in FIG. 10. As shown in FIG. 10, the maximum incident angle is 8° over the entire angle of view, and the viewing angle characteristic of 8° is sufficient for the waveplate element 24. Therefore, the retardation difference of the waveplate element 24 due to the angle of view is reduced, and the phase is substantially accurately changed at all the wavelengths of the video light ML emitted from the image display panel 11. Accordingly, the luminance unevenness, the color unevenness, and the ghost of the display video can be suppressed.

Further, when the region through which the beam at the end of the angle of view passes is exposed with the spherical wave inclined at ±5° or less with respect to the normal angle along the curved surface gradient of the second optical surface 21b, the viewing angle characteristics required for the waveplate element 24 are within the range of ±5°, and thus the video quality can be improved.

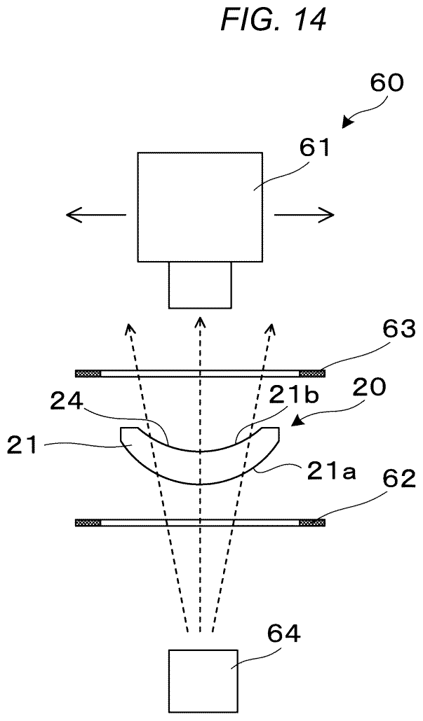

FIG. 14 illustrates verification of the viewing angle characteristics of the waveplate element 24. As illustrated in FIG. 14, an observation device 60 includes a camera 61, a first polarizer 62, a second polarizer 63, and a light source 64. The polarization direction of the first polarizer 62 and the polarization direction of the second polarizer 63 are orthogonal to each other. The lens member 21 provided with the waveplate element 24, which is an observation object, is sandwiched between the first polarizer 62 and the second polarizer 63, and the camera 61 is moved for observation of a crossed Nicols pattern of the waveplate element 24 illuminated by the light source 64. Accordingly, the phase difference of the waveplate element 24 on the second optical surface 21b can be quantitatively measured. In the crossed Nicols pattern, the pattern (phase difference) changes depending on the viewing angle. In the case of a sample subjected to spherical wave exposure, when observed from the front, the color changes between the center of the optical surface and the end portion of the optical surface. Further, in the case of the sample subjected to spherical wave exposure, when observed obliquely, the end portion of the optical surface appears in the same color as the center of the optical surface in the front view depending on the viewing angle. From the above, it can be seen that the phase difference between the center of the optical surface viewed from the front and the end portion of the optical surface viewed from the oblique direction matches. On the other hand, in the case of a sample subjected to plane wave exposure, the entire second optical surface 21b appears in the same color when viewed from the front.

The phase difference can also be measured by, for example, a phase difference measurement method. In the phase difference measurement method, the polarization state of the input is changed among, for example, four polarization states (specifically, horizontal polarization, vertical polarization, right circular polarization, and left circular polarization), and the lens member 21 provided with the waveplate element 24 is irradiated with each polarized light. The amount of phase change of the waveplate element 24 can be grasped by measuring the received light intensity of each polarized light with respect to the light transmitted through the waveplate element 24.

The virtual image display devices 100 A and 100 B and the optical unit 100 according to the first embodiment described above include the display 10 that emits the circularly polarized video light ML, and the optical member 20 that forms a virtual image by reflecting and folding the video light ML twice, and the optical member 20 includes the lens member 21 having one or more lenses, the transmissive reflection optical element 22 provided to face the first optical surface 21a of the lens member 21 closer to the display 10, the reflective polarization optical element 25 provided to face the second optical surface 21b of the lens member 21 farther from the display 10 and reflecting the video light ML that is linearly polarized light in the first polarization direction, and the waveplate element 24 provided between the reflection optical element 22 and the polarization optical element 25, formed of the photocrosslinkable polymer liquid crystal material CS, and converting the video light ML passing through the reflection optical element 22 into linearly polarized light in the first polarization direction and converting the video light ML reflected by the reflection optical element 22 and reciprocated to the waveplate element 24 into linearly polarized light in the second polarization direction, and the waveplate element 24 has orientation of d±5° or less with respect to the gradient normal angle d of the optical surface on which the waveplate element 24 is provided.

In the virtual image display device described above, since the waveplate element 24 has the orientation along the optical surface of the lens member 21, specifically, the gradient of the second optical surface 21b, the lens member 21 can be provided with a function of a waveplate substantially along the shape of the optical surface. Accordingly, deterioration (specifically, luminance unevenness, color unevenness, and ghost) of video quality of the display image can be suppressed.

Note that the first polarization direction and the second polarization direction are for convenience, and the definitions of the specific directions can be changed. That is, in the example illustrated in FIG. 2 and the like, the polarization optical element 25 reflects the first polarized light L1 in the first polarization direction as the X direction, but the polarization optical element 25 may reflect the first polarized light L1 in the first polarization direction as the Y direction.

### Second Embodiment

A virtual image display device and the like according to a second embodiment will be described below. Note that the virtual image display device according to the second embodiment is a partially changed version of the virtual image display device according to the first embodiment, and the description of the portions common to those of the virtual image display device according to the first embodiment will be omitted.

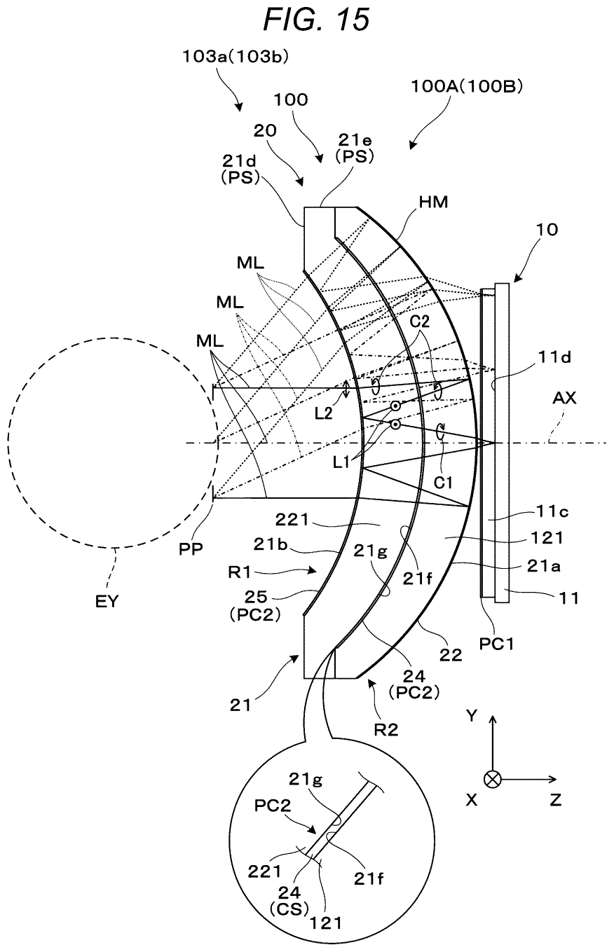

FIG. 15 is a side cross-sectional view illustrating an optical structure of display optical systems 103a and 103b of virtual image display devices 100 A and 100 B according to the second embodiment. As illustrated in FIG. 15, in the first display optical system 103a, the lens member 21 of the optical member 20 is a meniscus lens having positive power as a whole, and includes two or more lenses 121, 221. That is, the lens member 21 includes the first lens 121 and the second lens 221 in order from the display 10 side. The first lens 121 and the second lens 221 are bonded to each other via the waveplate element 24.

A third optical surface 21f at the emission side of the first lens 121 is a concave surface, and a fourth optical surface 21g at the incidence side of second lens 221 is a convex surface. The radius of curvature of the fourth optical surface 21g coincides or substantially coincides with the radius of curvature of the third optical surface 21f. In this case, the waveplate element 24 has a shape following the curved third optical surface 21f and fourth optical surface 21g. That is, the waveplate element 24 is provided between the first optical surface 21a and the second optical surface 21b, and is embedded inside the lens member 21.

In the lens member 21, the first radius of curvature R1 of the second optical surface 21b at the emission side and the second radius of curvature R2 of the first optical surface 21a at the incident side of the lens member 21 are set to satisfy the following expression.

$$0. 8 \leq R 2 / R 1 \leq 1.2$$

The ratio of the radii of curvature (R2/R1) preferably satisfies the following expression.

$$1. 0 \leq R 2 / R 1 \leq 1.2$$

In the lens member 21, the photocrosslinkable polymer liquid crystal material CS is applied to one of the fourth optical surface 21g of the second lens 221 and the third optical surface 21f of the first lens 121 and spherical wave exposure is performed thereon, thereby forming the waveplate element 24. In this case, in the spherical wave exposure shown in FIG. 4, exposure with substantially spherical wave of d±5° or less is performed with respect to the gradient normal angle d of the optical surface (the fourth optical surface 21g of the second lens 221 in the example of FIG. 15) of the lens member 21 with the photocrosslinkable polymer liquid crystal material CS applied thereto. One of the first and second lenses 121, 221 serves as a base material, and the other serves as a cover glass. When the periphery of the lens member 21 is sealed with an adhesive or the like, entry of moisture or the like can be prevented and deterioration of the waveplate element 24 can be suppressed.

When the first lens 121 and the second lens 221 have different refractive indices, a lens effect can be produced between the glass materials, and further increase in resolution and decrease in size, thickness, and weight of the entire optical system can be implemented.

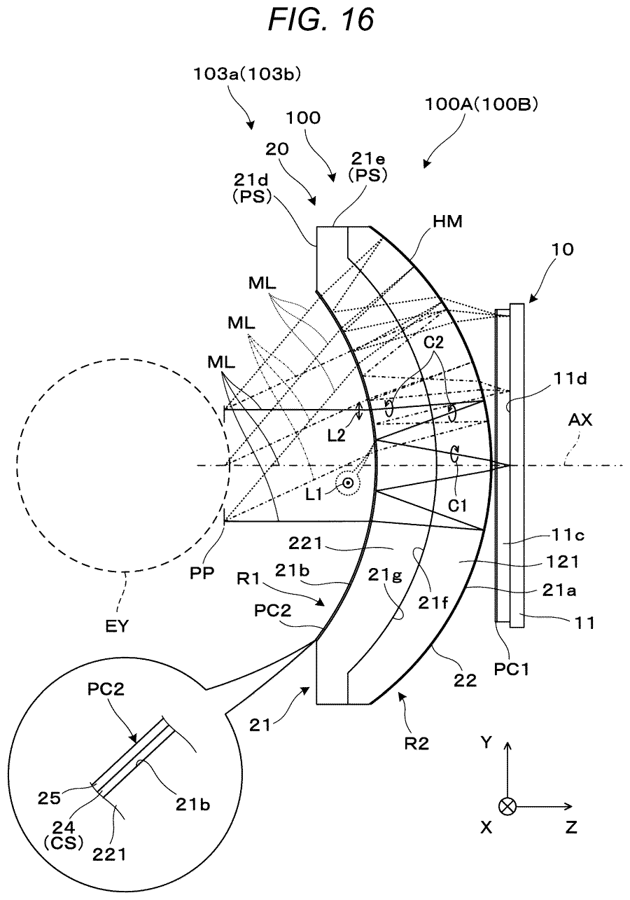

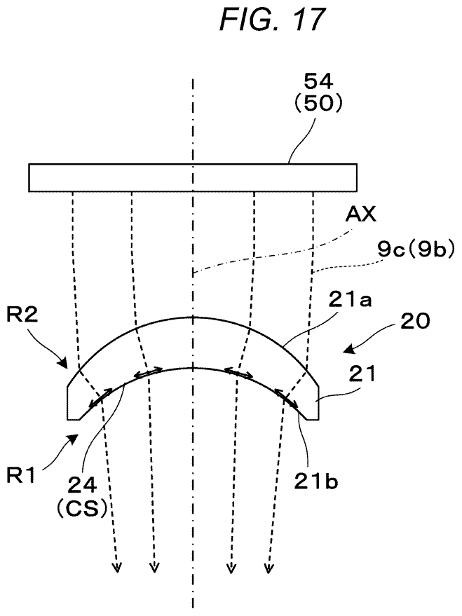

Note that, in a case where the lens member 21 includes two or more lenses, as illustrated in FIG. 16, the waveplate element 24 may be provided between the second optical surface 21b and the polarization optical element 25. Alternatively, a gap may be provided between the first lens 121 and the second lens 221. In this case, the waveplate element 24 is provided at, for example, the second lens 221 provided with the polarization optical element 25. Specifically, the waveplate element 24 is provided on the fourth optical surface 21g at the incident side or the second optical surface 21b at the emission side of the second lens 221.

### Modifications and Others

The present disclosure has been described above with reference to the embodiments, but is not limited to the embodiments described above, and can be implemented in various aspects without departing from the scope of the present disclosure. For example, modifications below are conceivable.

FIG. 17 illustrates fabrication of the waveplate element 24 according to a modification of the first embodiment. As illustrated in FIG. 17, in the fabrication of the waveplate element 24, the photocrosslinkable polymer liquid crystal material CS applied onto the second optical surface 21b may be subjected to plane wave exposure from the first optical surface 21a side, that is, the curved surface side having the second radius of curvature R2, by using the refraction effect of the first optical surface 21a of the lens member 21. In this case, the first and second radii of curvature R1 and R2 of the lens member 21 are adjusted so that the angle difference between the beam incident angle of the exposure light 9c and the gradient normal angle d is +5° or less. The first and second radii of curvature R1 and R2 are set to satisfy, for example, the following expression.

$$R 2 = 0.6 ★ R 1$$

### Example 3

Hereinafter, Example 3 of the modification will be described. Parameters of the first display optical system 103a of Example 3 are shown below.

FOV: 100°

The lens thickness D3: 8.8 mm

The distance D2 from the pupil position PP to the center of the second optical surface 21b: 13.3 mm

The first radius of curvature R1 of the second optical surface 21b: 48.90 mm

The second radius of curvature R2 of the first optical surface 21a: 29.50 mm

The ratio of the radii of curvature (R2/R1)=0.603

In the above embodiments, the lens member 21 incorporated in the optical member 20 is merely an example, and the lens member may include one or two lenses in a bonded state or a separated state. Even when the lens member 21 includes two or more lenses, a ratio of the radii of curvature (R2/R1) between the first radius of curvature R1 of the optical surface facing the reflection surface of the polarization optical element 25 and the second radius of curvature R2 of the optical surface facing the reflection surface of the reflection optical element 22 is considered.

Although not essential, the optical member 20 desirably has the FOV of 100° or more, and the thickness from the display 10 to the rear end emission surface 21c at the outer edge or the center of the optical member 20 is desirably 20 mm or less.

In the above description, it is assumed that the HMD 200 is mounted on the head and used. However, the virtual image display devices 100 A and 100 B can also be used as a hand-held display that is not mounted on the head, but is seen through like binoculars. That is, in the present disclosure, the head-mounted display also includes a hand-held display.

The polarization state illustrated in FIG. 2 and the like is an example. For example, the video light ML emitted from the display 10 can be left circularly polarized light, and in this case, the polarization optical element 25 is required to selectively reflect only linearly polarized light (vertically polarized light) in the polarization direction corresponding to the Y direction as the vertical direction, and selectively transmit linearly polarized light (horizontally polarized light) in the polarization direction corresponding to the X direction as the horizontal direction.

The exposure of the photocrosslinkable polymer liquid crystal material CS for fabrication of the waveplate element 24 is not limited to the case of being performed from the optical surface side with the photocrosslinkable polymer liquid crystal material CS applied thereto, but may be performed from the optical surface side opposite to the optical surface with the photocrosslinkable polymer liquid crystal material CS applied thereto. Also, in this case, the exposure is performed at d±5° or less with respect to the gradient normal angle d of the optical surface on which the waveplate element 24 is provided.

A first virtual image display device according to a specific aspect includes a display configured to emit circularly polarized video light, and an optical member configured to form a virtual image by reflecting and folding the video light twice, wherein the optical member includes a lens member including one or more lenses, a transmissive reflection optical element provided to face a first optical surface of the lens member closer to the display, a reflective polarization optical element provided to face a second optical surface of the lens member farther from the display, and reflecting the video light that is linearly polarized light in a first polarization direction, and a waveplate element provided between the reflection optical element and the polarization optical element, formed of a photocrosslinkable polymer liquid crystal material, converting the video light passing through the reflection optical element into linearly polarized light in the first polarization direction, and converting the video light reflected by the reflection optical element and reciprocated to the waveplate element into linearly polarized light in a second polarization direction, and the waveplate element has orientation of d±5° or less with respect to a gradient normal angle d of an optical surface on which the waveplate element is provided.

In the virtual image display device, since the waveplate element has the orientation along the gradient of the optical surface of the lens member, the lens member can be provided with a function of a waveplate substantially along the shape of the optical surface. Accordingly, deterioration (specifically, luminance unevenness, color unevenness, and ghost) of video quality of the display image can be suppressed.

In the virtual image display device in the specific aspect, when the lens member has an F-number of 1 or more, 0.8≤R2/R1≤1.2, R1 being a first radius of curvature of the second optical surface and R2 being a second radius of curvature of the first optical surface.

In this case, the first and second optical surfaces of the lens member satisfy the above expression, and thus the radius of curvature of the reflection optical element as the reflection surface facing the first optical surface and the radius of curvature of the polarization optical element as the reflection surface facing the second optical surface can be controlled, and the differences in beam angle when the beam is incident on the waveplate element three times can be reduced. Accordingly, the display video can be further improved.

In the virtual image display device in the specific aspect, the waveplate element is provided between the second optical surface and the polarization optical element.

In the virtual image display device in the specific aspect, the lens member includes two or more lenses, and the waveplate element is provided between the first optical surface and the second optical surface.

In the virtual image display device in the specific aspect, the first optical surface is a convex surface, and the second optical surface is a concave surface. The first optical surface is the convex surface, and thus the reflection optical element can be provided with positive power, and the virtual image display device can be easily downsized by reducing the distance between the display and the optical member. Further, the second optical surface is the concave surface, and thus the refraction of the principal ray in the second optical surface of the lens member can be reduced as a whole, and the aberration of the optical member can be easily reduced.

In the virtual image display device in the specific aspect, the polarization optical element is one of a wire grid polarizer, a multilayer film, and a dielectric multilayer film. In this case, even when the optical surface is a curved surface, it is easier to form the polarization optical element on the optical surface.

In the virtual image display device in the specific aspect, the display includes an image display panel and a polarization control member that converts the video light emitted from the image display panel into circularly polarized light.

In the virtual image display device in the specific aspect, the polarization control member includes a linear polarizer and a waveplate in order from the image display panel side.

In the virtual image display device in the specific aspect, the lens member has a first end surface extending from the second optical surface in a radial direction perpendicular to an optical axis and a second end surface orthogonal to the first end surface. In this case, the first and second end surfaces function as positioning portions or positioning surfaces.

In the virtual image display device in the specific aspect, the lens member has a first end surface extending from the second optical surface in a radial direction perpendicular to an optical axis, and the first end surface is not provided with the waveplate element or the polarization optical element and has an exposed surface. In this case, unnecessary reflection of video light can be prevented.

An optical unit according to a specific aspect includes a display configured to emit circularly polarized video light, and an optical member configured to form a virtual image by reflecting and folding the video light twice, wherein the optical member includes a lens member including one or more lenses, a transmissive reflection optical element provided to face a first optical surface of the lens member closer to the display, a reflective polarization optical element provided to face a second optical surface of the lens member farther from the display, and reflecting the video light that is linearly polarized light in a first polarization direction, and a waveplate element provided between the reflection optical element and the polarization optical element, formed of a photocrosslinkable polymer liquid crystal material, converting the video light passing through the reflection optical element into linearly polarized light in the first polarization direction, and converting the video light reflected by the reflection optical element and reciprocated to the waveplate element into linearly polarized light in a second polarization direction, and the waveplate element has orientation of d±5° or less with respect to a gradient normal angle d of an optical surface on which the waveplate element is provided.

What is claimed is:

1. A virtual image display device, comprising:
a display configured to emit circularly polarized video light; and
an optical member configured to form a virtual image by reflecting and folding the video light twice, wherein
the optical member includes:
a lens member including one or more lenses,
a transmissive reflection optical element provided to face a first optical surface of the lens member closer to the display,
a reflective polarization optical element provided to face a second optical surface of the lens member farther from the display, and reflecting the video light that is linearly polarized light in a first polarization direction, and
a waveplate element provided between the reflection optical element and the polarization optical element, formed of a photocrosslinkable polymer liquid crystal material, converting the video light passing through the reflection optical element into linearly polarized light in the first polarization direction, and converting the video light reflected by the reflection optical element and reciprocated to the waveplate element into linearly polarized light in a second polarization direction, and
the waveplate element has an orientation of d±5° or less with respect to a gradient normal angle d of an optical surface on which the waveplate element is provided.

2. The virtual image display device according to claim 1, wherein
when the lens member has an F-number of 1 or more, 0.8≤R2/R1≤1.2, R1 being a first radius of curvature of the second optical surface and R2 being a second radius of curvature of the first optical surface.

3. The virtual image display device according to claim 1, wherein
the waveplate element is provided between the second optical surface and the polarization optical element.

4. The virtual image display device according to claim 1, wherein
the lens member includes two or more lenses, and
the waveplate element is provided between the first optical surface and the second optical surface.

5. The virtual image display device according to claim 1, wherein
the first optical surface is a convex surface, and
the second optical surface is a concave surface.

6. The virtual image display device according to claim 1, wherein
the polarization optical element is one of a wire grid polarizer, a multilayer film, and a dielectric multilayer film.

7. The virtual image display device according to claim 1, wherein
the display includes an image display panel and a polarization control member that converts the video light emitted from the image display panel into circularly polarized light.

8. The virtual image display device according to claim 7, wherein
the polarization control member includes a linear polarizer and a waveplate in order from the image display panel side.

9. The virtual image display device according to claim 1, wherein
the lens member has a first end surface extending from the second optical surface in a radial direction perpendicular to an optical axis and a second end surface orthogonal to the first end surface.

10. The virtual image display device according to claim 1, wherein
the lens member has a first end surface extending from the second optical surface in a radial direction perpendicular to an optical axis, and
the first end surface is not provided with the waveplate element or the polarization optical element and has an exposed surface.

11. An optical unit, comprising:
a display configured to emit circularly polarized video light; and
an optical member configured to form a virtual image by reflecting and folding the video light twice, wherein
the optical member includes
a lens member including one or more lenses,
a transmissive reflection optical element provided to face a first optical surface of the lens member closer to the display,
a reflective polarization optical element provided to face a second optical surface of the lens member farther from the display, and reflecting the video light that is linearly polarized light in a first polarization direction, and
a waveplate element provided between the reflection optical element and the polarization optical element, formed of a photocrosslinkable polymer liquid crystal material, converting the video light passing through the reflection optical element into linearly polarized light in the first polarization direction, and converting the video light reflected by the reflection optical element and reciprocated to the waveplate element into linearly polarized light in a second polarization direction, and
the waveplate element has orientation of d±5° or less with respect to a gradient normal angle d of an optical surface on which the waveplate element is provided.
